(19) United States
(12) Patent Application Publication
(10) Pub. No.: US 2026/0176067 A1
(43) Pub. Date: Jun. 25, 2026

(54) STORAGE SYSTEM WITH A MULTI-LEVEL STORAGE RACK AND METHOD OF OPERATION FOR PROVIDING TRANSPORT UNITS FROM A STORAGE FACILITY ON AT LEAST ONE REMOVAL LINE

(71) Applicant: Dematic GmbH, Heusenstamm (DE)

(72) Inventors: Shin Yamashita, Singapore (SG); Marisa Neher, Rödermark (DE)

(21) Appl. No.: 19/125,622

(22) PCT Filed: Oct. 31, 2022
(86) PCT No.: PCT/EP2022/080371

§ 371 Date: Apr. 29, 2025

(51) Int. Cl. B65G 1/04; B65G 1/06; G06Q 10/087

(52) U.S. Cl. CPC B65G 1/0492; B65G 1/065; G06Q 10/08741

(57) ABSTRACT

A storage system for transport units with a plurality of storage racks with multiple storage rack levels for storage of the transport units having storage locations that are at least double deep. The storage racks have a storage racking aisle between them and at least one automated storage and retrieval apparatus that travels along each storage racking aisle for carrying transport units. The automate storage and retrieval apparatus includes load handling means for displacing transport units into storage locations that are at least double deep and for removal of transport units from storage locations that are at least double deep. A control is provided for the system and its components, where the control is operable to control the automated storage and retrieval apparatus to place the transport units in a depth position of a storage location based on a categorization of items within the transport units.

### CROSS REFERENCE TO RELATED APPLICATION

The present application claims the priority benefits of International Patent Application No. PCT/EP2022/080371, filed Oct. 31, 2022.

### BACKGROUND AND FIELD OF THE INVENTION

When picking or compiling orders from ready-picked transport units, such as articles or containers, it is necessary to provide the transport units, which are associated with a common order, in a sequenced or sorted manner. For this purpose, it is typical to temporarily store (buffer) the transport units of one order until all of the transport units required for the order are present. They are then passed collectively onto a collecting line, which guides them to the palletization area, picking station, goods issuing department, dispatch, or the like.

A high rack storage facility includes a feeding or storage-entry area, via which the goods are delivered and from which the racking serving units collect the goods for entry into storage, the so-called pre-zone. Similarly, a removal-from-storage area is required, at which after removal from storage the racking serving units place down the goods also assigned to the pre-zone. In the case of automatic picking warehouses, picking points are typically arranged in the pre-zone. The pre-zone is also where the goods are identified for the inventory management system or the material flow computer.

EP 1 964 792 B1 discloses a method for providing transport units from a storage facility in a desired sequence on at least one collecting line. Racking serving units in each storage-racking aisle, removal lifts and removal-feeding lines are controlled so as to be coordinated with one another and are loaded with goods such that they ultimately end up sorted on the collecting line or are delivered thereby. The control and coordination are therefore relatively complex and require technical outlay in the so-called pre-zone outside the actual racking.

EP 2 741 977 A1 discloses a method for providing transport units from a storage facility on at least one removal line, wherein the transport units are stored in a plurality of storage racks and storage rack levels, wherein interior storage racks are arranged in pairs adjoining one another and have a storage aisle on each side of the pair. At least one storage line and at least one removal line are provided. The transport units are placed into storage and removed from storage via a storage and removal apparatus for each access aisle. For each access aisle, a storage and removal apparatus is provided. At least one removal lift is used to transfer the transport units to the removal line connected downstream thereof. A direct exchange of transport units takes place between two adjoining storage racks from one access aisle to an adjacent access aisle via transverse conveyance locations in the storage racks. The storage and removal apparatus moves the transport units in the transverse conveyance locations.

US 2014/0124462 A1 discloses a multi-tier automated warehouse including first and second stacking racks having multiple tiers of shelves and being positioned facing one another in parallel; loading shuttles which are capable of horizontal travel between the stacking racks, and which carry out loading and unloading of cargo upon the shelves; and an elevator device for moving the loading shuttles to different tiers. The elevator device further includes masts which are positioned adjacent to the stacking racks; a shuttle elevator platform, which is positioned elevatable on the inner side of the masts, for elevating the loading shuttles; and cargo elevator platforms, which are positioned elevatable on the outer side of the masts, for elevating the cargo. In a state where the shuttle elevator platform is aligned with the cargo elevator platforms, it is possible for the loading shuttles on the shuttle elevator platforms to carry out cargo loading and unloading to the cargo elevator platforms, allowing handling cargo even while the loading shuttles are being elevated, obviating the need for wasteful waiting for cargo. As a result, it is possible to implement high performance. In this context, as illustrated in FIG. 4, the multi-tier racks may be divided into upper and lower parts, the waiting platforms being provided at each tier in the lower part and no waiting platforms being provided in the upper part, or vice versa. In the embodiment illustrated in FIG. 4, the upper part will correspond to the roaming-type automated storage/retrieval system according to the first embodiment, and the lower part will correspond to the captive-type automated storage/retrieval system in which a transferring shuttle is provided at each tier. This design is intended to make part of the automated storage/retrieval system the roaming-type and to store slow moving loads to be stored or retrieved in this part, restraining increase of costs, and to make the remaining part thereof almost captive-type or completely captive-type and to store so-called fast moving loads to be stored or retrieved in this remaining part, thus maximizing throughput performance. Accordingly, this design is advantageous for a high-rise automated storage/retrieval system and/or an automated storage/retrieval system that stores loads whose storage and retrieval frequencies are various.

### SUMMARY OF THE INVENTION

It is an objective of the present invention to provide a storage system that combines the advantages of roaming shuttles and captive shuttles while roaming movement is minimized.

By providing a storage system for transport units in which the control is operable to control an automated storage and retrieval apparatus to place the transport units in a depth position of a storage location based on a categorization of items within the transport units, it is possible to increase throughput in systems with the same footprint and same number of storage locations or maintain performance with increased number of storage locations.

Minimum retrieval lead time results in less conflicts among storage and retrieval machines and it increases machine utilization. Additionally, it may extend maintenance intervals and reduce power consumption and number of machine failures.

In a preferred embodiment, the control is operable to categorize items within the transport units as fast movers, medium movers or slow movers based on the features of the items within the transport units.

In the present application fast movers, medium movers and slow movers are categorized as such based on the rate of rotation at which the item/product is exchanged. Fast-moving items or fast movers are items that spend little time in the warehouse and leave it again quickly. Here, large quantities are handled in a short time. They are not stored for a long time, so they hardly block any storage space and incur only low storage costs. Slow movers are items that have a low rate of exchange. They are stored in the warehouse for a long period of time and block storage space. Medium movers are items that have a rate of exchange that lies between that of fast movers and slow movers. The categorization into fast, slow or medium movers may be done by a so-called ABC analysis. The control may be operable to perform the categorization dynamically.

The control is beneficially operable to control the automated storage and retrieval apparatus to place fast movers in front storage locations, medium movers in double deep and slow movers in triple deep storage locations (or deeper/deepest). In other words, the items with the highest turnaround are stored in the most accessible space (at the front most storage space in terms of access by the ASRS). Likewise, the items with the lowest turnaround are stored in the least accessible space (at the back). In-between the items with medium turnaround are stored.

The control may be operable to perform the categorization based on at least one or more of (i) product attributes (e.g. customer product velocity data, e. g. urgency of need), (ii) product status (e. g. reserve or active, dead storage and/or products prohibited to be shipped), (iii) load unit status (e. g. non-allocated inventory, allocation of load unit to particular order routed or being routed and buffered at destination aisle etc., (iv) operational log (how often is each product retrieved within a given time, see above)), (v) by expected machine resource consumption (e. g. of the ASRS), (vi) predicted product velocity (e. g. seasonable sales trend, promotion, obsolesces due to new product release etc.).

All these factors may be used to train a neural network of an artificial intelligence (Al) which could be used by the control to improve dynamic categorization.

Additionally, the control may be operable to keep empty storage locations evenly spread over the storage aisle length for each depth and a storage location is chosen in the area closest to the next retrieval location and with the emptiest locations.

To improve the throughput especially for the fast movers, the control may be operable to choose a storage location and depth close to an exit of the storage for next items to be retrieved. The exit will be located nearby a discharge system, like a conveyor or lift etc. that leads transport units out of the rack. Such a lift will have a vertically moveable lift carriage for the vertical transport and interface with conveyors, preferably on each level to allow decoupling from the automated storage and retrieval apparatus.

The system will preferably have one or more automated storage and retrieval apparatus which may be of the shuttle type, unit load AS/RS type, 2D shuttle type, satellite system type, or mixtures of these.

In a preferred embodiment, the storage system includes at least one storage-entry feeding line; at least one removal-from storage feeding line; at least one removal-from-storage lift used to transfer the transport units to the removal-from-storage feeding line; at least one supply-to-storage lift used to transfer the transport units from the at least one storage-entry feeding line; rack conveyors interfacing the removal-from-storage lift and the supply-to-storage lift, preferably in every storage rack level.

The invention is also directed to a method of operating a storage system, especially according to the above description, for the storage of transport units in storage locations that are at least double deep and are arranged in a plurality of storage racks with multiple storage rack levels for storage of the transport units, the storage racks have a storage racking aisle between them, and at least one automated storage and retrieval apparatus is controlled to travel along each storage racking aisle, wherein the automated storage and retrieval apparatus has means for carrying transport units and load handling means for displacing transport units into the storage locations that are at least double deep and removal of transport units from the storage locations that are at least double deep. In the method the automated storage and retrieval apparatus is controlled to place the transport units in a depth position of a storage location based on features of items within the transport units.

The invention minimizes shuffle/rearrangement operations in the storage/racks and makes sure the system can be operated efficiently.

Further details of the invention will now be explained with reference to the provided figure.

### BRIEF DESCRIPTION OF THE DRAWINGS

FIG. 1 discloses a schematic top view of a possible embodiment of a storage system is shown in accordance with the present disclosure.

### DESCRIPTION OF THE PREFERRED EMBODIMENTS

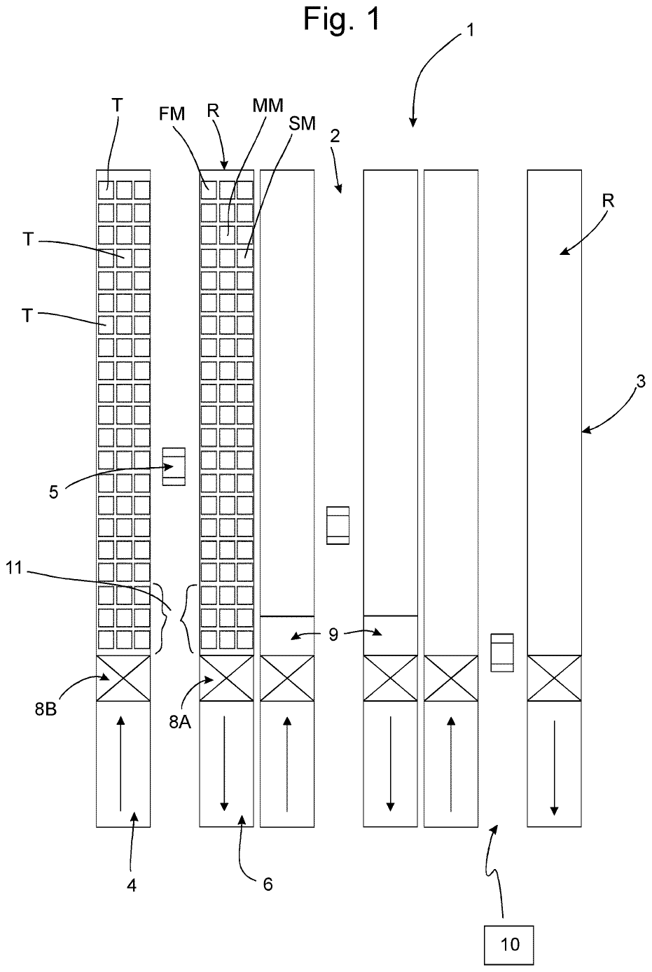

The storage system as a whole is denoted with 1 and allows storage of transport units generally referenced with T in a plurality of storage racks R with multiple storage rack levels 3 for storage of the transport units T having storage locations that are triple deep. For the sake of understanding, only the two left racks R are shown in FIG. 1 to have transport units T stored in front, middle, or back of the triple deep storage locations or positions—with respect or reference to the aisle 2. FIG. 1 only shows three aisles 2 with racks, however it is obvious that a storage system may include any number of racks R.

The storage racks R are arranged in pairs that have a storage racking aisle 2 between them. The inner racks R of respective pairs are arranged back-to-back, i. e. abutting or adjacent. In each level 3 and aisle 2 an automated storage and retrieval apparatus of the shuttle type 5 travels along the length of each storage racking aisle 2.

The load units T may be trays, totes, containers etc. and be of the storage type in which a product is stored so to be picked from when fulfilling orders. The load units T may also be of the order type into which a product is put or placed according to an order for fulfilling said order at least partially. They are in general retrieved very quickly so that they have characteristics of fast movers (as defined above).

Each storage rack level has running rails on the opposing faces of the storage racks R, on which at least one shuttle 5 may travel the length of the aisle 2. The storage racks have load rails on which the load units T are placed and that are supported between the running rails on one side and longitudinal support rails on the other side. The ledgers are arranged perpendicular to the longitudinal extension of the rack R (or aisle 2). Two (or more) ledgers support each load unit T (e. g. tray) from below. The ledgers are arranged along the storage space of each rack R and level 3. The running rails and longitudinal support rails are attached to uprights 13. The uprights 13 either face the aisle 2 or are located between racks R that are arranged back-to-back.

Every five levels a maintenance platform is arranged in the aisle 2 so that maintenance personnel may access the aisle 2, racks R and shuttles 5 etc. if necessary.

In the present embodiment the shuttles 5 have a carrying area for at least one load unit T, located between load handling means that may extend (to both sides) into the storage racks R in a direction perpendicular to the length of the aisle 2, for placing or retrieval of load units T into or from the storage racks R. Load handling means include telescopic rails that can be extended to both sides of the carrying area and have contact elements that can be swiveled between an upright non-use position and a horizontal use-position, in which the contact elements will contact the face of a load unit T when pushing into the racks R or pulling from the racks R or onto the carrying area in a known manner.

Each shuttle 5 has a first set of four traveling wheels for traveling along the running rails horizontally along the respective storage rack level 3 of an aisle 2. Two wheels per set on each side of the shuttle 5, one or both of each side being driven by a motor via a joint driven axis.

The storage system 1 includes a storage-entry feeding line 4 and a removal-from storage feeding line 6 for each aisle 2, that respectively connect to a removal-from-storage lift 8A used to transfer the transport units T to the removal-from-storage feeding line 6 and a supply-to-storage lift 8B used to transfer the transport units T from the at least one storage-entry feeding line 4. The respective feeding lines will be further connected or interfaced with additional material handling installations of a warehouse, like picking areas with GTP stations or packing stations, shipping areas etc.

Optionally, rack conveyors 9 interfacing the removal-from-storage lift 8A and the supply-to-storage lift 8B preferably in every storage rack level 3 may be present to decouple handling of the transport units T by the shuttles 5 from the lift 8A, B transportation. Therefore, these are only indicated in the middle aisle in FIG. 1.

The rails for the shuttles 5 may extend along the aisle 2 to allow access of the shuttle 5 to the rack conveyors 9 and/or the lifts 8A, B.

The system 1 includes a main control 10 for the control of the system and its components. The control 10 is operable to control said shuttles 5 to place the transport units T in a depth position (front, middle, or back of the triple deep storage) of a storage location based on a categorization of items within the transport units T.

The control 10 is operable to categorize items within the transport units T as fast movers FM, medium movers MM or slow movers SM based on the features of the items within the transport units T. As such fast movers FM, medium movers MM and slow movers SM are categorized as such based on the rate of rotation at which the respective item/product is exchanged. The control 10 is operable to perform the categorization dynamically.

The control is operable to control the shuttles 5 to place fast movers FM in front storage locations, medium movers MM in double deep and slow movers SM in triple deep storage locations. In other words, the items with the highest turnaround are stored in the most accessible space (at the front most storage space in terms of access by the ASRS). Likewise, the items with the lowest turnaround are stored in the least accessible space (at the back). In-between the items with medium turnaround are stored.

The control 10 is additionally operable to keep empty storage locations evenly spread over the storage aisle length for each depth and a storage location is chosen in the area with the most empty locations.

To improve the throughput especially for extreme fast movers, the control is operable to choose a storage location 11 and depth close to a conveyor 9 or lift 8B that lead transport units T out of the rack.

1. A storage system for transport units comprising:
a plurality of storage racks with multiple storage rack levels for storage of the transport units, wherein the storage racks have storage locations that are at least double deep, and wherein pairs of the storage racks each have a storage racking aisle between them;
at least one automated storage and retrieval apparatus that travels along each storage racking aisle, wherein the automated storage and retrieval apparatus has a carrying area for carrying transport units and has a load handler for displacing transport units into storage locations that are at least double deep and for removal of transport units from storage locations that are at least double deep; and
at least one control for the control of the system and its components;
wherein the control is operable to control said automated storage and retrieval apparatus to place the transport units in a depth position of the storage locations based on a categorization of items within the transport units.

2. The storage system according to claim 1, wherein the control is operable to categorize items within the transport units based on product velocity as fast movers, medium movers or slow movers based on the features of the items and/or product attribute within the transport units.

3. The storage system according to claim 2, wherein the control is operable to control said automated storage and retrieval apparatus to place fast movers closer to the aisle and slow movers further away from the aisle in depth in front storage locations, and wherein medium movers are placed in double deep and slow movers in triple deep storage locations (or deeper/deepest).

4. The storage system according to claim 3, wherein the control is operable to perform the categorization dynamically.

5. The storage system according to claim 4, wherein the control is operable to perform the categorization based on at least one or more of (i) product attributes, (ii) product status, (iii) load unit status, (iv) operational log, (v) predicted product velocity, and (iv) expected machine resource consumption.

6. The storage system according to claim 3, wherein the control is operable to keep empty storage locations evenly spread over the storage aisle length for each depth and a storage location is chosen in the area with the emptiest locations.

7. The storage system according to claim 2, wherein the control is operable to choose a storage location and depth close to an exit of the storage for next items to be retrieved.

8. The storage system according to claim 1, wherein the automated storage and retrieval apparatus is of the shuttle type, unit load AS/RS type, 2D shuttle type or satellite system type.

9. The storage system according to claim 1, further comprising;
at least one storage-entry feeding line;
at least one removal-from storage feeding line;
at least one removal-from-storage lift used to transfer the transport units to the removal-from-storage feeding line;
at least one supply-to-storage lift used to transfer the transport units from the at least one storage-entry feeding line and;
rack conveyors interfacing the removal-from-storage lift and the supply-to-storage lift.

10. The storage system according to claim 9, wherein the control is operable to choose a storage location and depth close to a conveyor or lift that transports transport units out of the storage rack.

11. (canceled)

12. The storage system according to claim 9, wherein the rack conveyors interfacing the removal-from storage lift and the supply-to-storage lift are provided at every storage rack level.

13. The storage system according to claim 2, wherein the control is operable to perform the categorization dynamically.

14. The storage system according to claim 13, wherein the control is operable to perform the categorization based on at least one or more of (i) product attributes, (ii) product status, (iii) load unit status, (iv) operational log, (v) predicted product velocity, and (iv) expected machine resource consumption.

15. The storage system according to claim 2, wherein the control is operable to perform the categorization based on at least one or more of (i) product attributes, (ii) product status, (iii) load unit status, (iv) operational log, (v) predicted product velocity, and (iv) expected machine resource consumption.

16. The storage system according to claim 3, wherein the control is operable to perform the categorization based on at least one or more of (i) product attributes, (ii) product status, (iii) load unit status, (iv) operational log, (v) predicted product velocity, and (iv) expected machine resource consumption.

17. The storage system according to claim 1, wherein the control is operable to keep empty storage locations evenly spread over the storage aisle length for each depth and a storage location is chosen in the area with the emptiest locations.

18. The storage system according to claim 3, wherein the control is operable to choose a storage location and depth close to an exit of the storage for next items to be retrieved.

19. A method of operating a storage system for the storage of transport units in storage locations that are at least double deep and are arranged in a plurality of storage racks with multiple storage rack levels for storage of the transport units, the storage racks having a storage racking aisle between them, and at least one automated storage and retrieval apparatus is controlled to travel along each storage racking aisle, wherein the automated storage and retrieval apparatus has a carrying area for carrying transport units and a load handler for displacing transport units into the storage locations that are at least double deep and for removal of transport units from the storage locations that are at least double deep, wherein said method comprises:
controlling the automated storage and retrieval apparatus to place the transport units in a depth position of a storage location based on features of items within the transport units.
